(19) United States
(12) Patent Application Publication
(10) Pub. No.: US 2004/0244252 A1
(43) Pub. Date: Dec. 9, 2004

(54) Tag attaching apparatus and method

(76) Inventor: Beth A. Phinney, Grandview, WA (US)

Correspondence Address: Floyd E. Ivey, Liebler, Ivey, Connor & Berry, P. O. Box 6125, Kennewick, WA, 99336, US

(21) Appl. No.: 10/457,952

(22) Filed: Jun. 9, 2003

(51) Int. Cl. G09F 3/14

(52) U.S. Cl. 40/665; 156/227; 156/196

(57) ABSTRACT

The invention provides a tag attaching apparatus and a method of affixing a tag or card to a container.

### FIELD OF THE INVENTION

This invention relates to the attachment of tags, labels and cards to bags and containers. More particularly, this invention relates to the apparatus which allows attachment of such items to a container.

### BACKGROUND OF THE INVENTION

This invention relates generally to the attachment of a tag, label, card or any item to a greeting card, a gift box or other container.

Apparatuses have been demonstrated which affix an identifying tag to a container or item. Such are seen in U.S. Pat. No. 5,366,249 to Diemert, U.S. Pat. No. 5,553,706 to Gold, and U.S. Pat. No. 6,497,063 to Stephens. In each instance the art disclosed comprises the tag. The patents referred to herein are provided herewith in an Information Disclosure Statement in accordance with 37 CFR 1.97.

### SUMMARY OF THE INVENTION

The present invention includes an apparatus which affixes a tag, label, card or such to a bag, card, container or other such item.

### BRIEF DESCRIPTION OF THE DRAWINGS

The foregoing and other features and advantages of the present invention will become more readily appreciated as the same become better understood by reference to the following detailed description of the preferred embodiment of the invention when taken in conjunction with the accompanying drawings, wherein:

FIG. 1 is a

### DETAILED DESCRIPTION

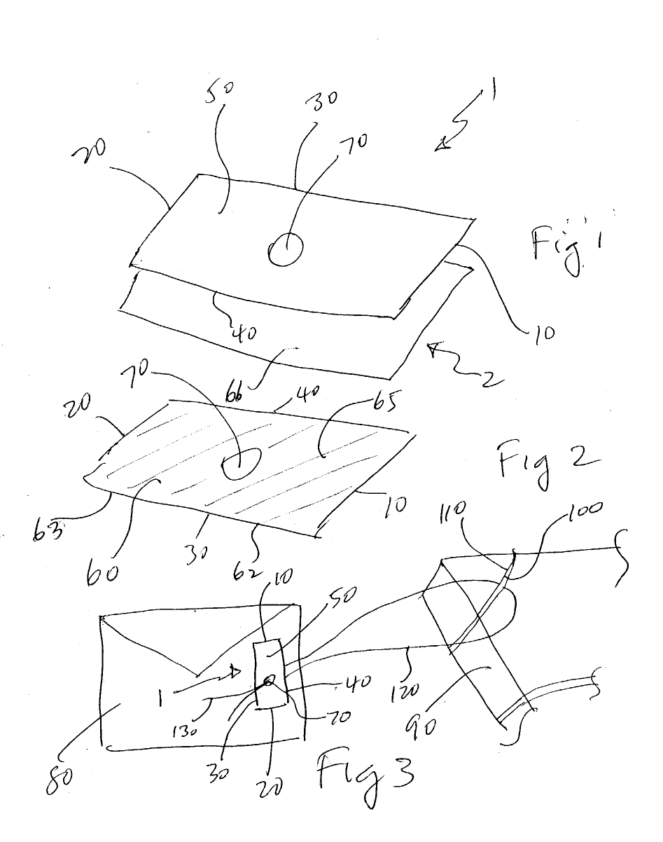

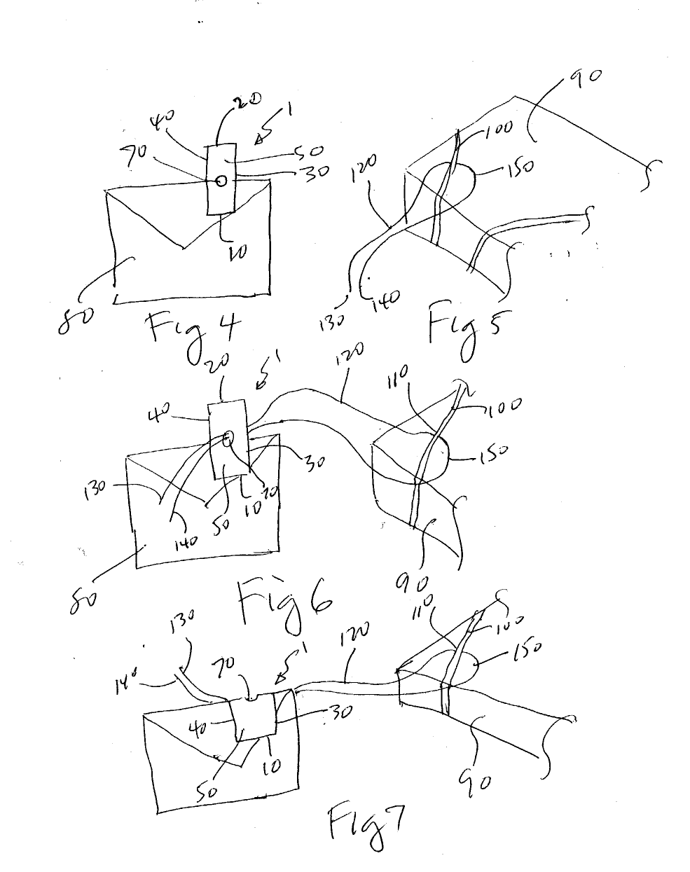

FIG. 1, 2 and 3 show a tag attaching apparatus (1) interconnecting a container (90) and a card (80). The tag attaching apparatus (1) for the attachment of a card (80)or tag to a gift or container (90), is generally composed of a paper or plastic strip with an adhesive on one side and an aperture between a first and a second end (10), (20). Other applications, for example the attachment of a card (80) or tag to a freight shipping container or a container requiring a seal for security purposes, may require the tag attaching apparatus (1) to be formed of material more durable than paper with such other materials including but not being limited to metal or cloth strips capable of folding and of receiving an adhesive on at least one side. Such alternative materials will be appreciated by those of ordinary skill in the arts. In some instances the tag attaching apparatus (1) may not be folded, as shown in FIG. 3, and in such instances the material forming the said tag attaching apparatus (1) may be inflexible but capable of being affixed with adhesive means to a container (90) or card (80). As seen in FIGS. 1, 2 and 3, an aperture (70) is formed from a top side to a bottom side (50), (60) which is sized to receive an interconnecting means (120).

The preferred embodiment of the tag attaching apparatus (1) comprises an elongated planar strip having a top side (50) and a bottom side (60); a first end (10) and a second end (20) and a first side (30) and a second side (40). An aperture (70) is formed from the top side (50) to the bottom side (60) intermediate the first end (10) and second end (20). The aperture (70) is also located intermediate the first side (30) and the second side (40). An adhesive means (65) is applied to the bottom side (60); a first adhesive section (62) extends from the first end (10) to the aperture (70) and a second adhesive section (63) from the second end (20) to the aperture (70).

The tag attaching apparatus (1) further comprises, in the preferred embodiment, the aperture (70) sized to receive an interconnecting means (120). It will be recognized that the attachment of a greeting card (80) or tag to a gift container (90) will be accomplished with the interconnecting means (120) composed of a ribbon or string or other such interconnecting means. For other applications, such as seals to provide an indication of security relative to the sealing of a container (90), a tag attaching apparatus (1) of a metal strip may be affixed to the container (90) via interconnecting means (120) composed of metal wire, wire rope, metal bands, metal ribbon and other such durable interconnecting means (120).

In the preferred embodiment the bottom side (60) of the tag attaching apparatus (1) will receive adhesive means (65). Such adhesive means may employ an adhesive as is used on the Post-It™ by 3M Company and any of many other adhesives depending on the application. e.g., the adhesive means (65) used to affix a tag attaching apparatus to a shipping container (90) may require an epoxy where the tag attaching apparatus (1) is a metal strip. Additionally, an adhesive protection means (2), as seen in FIG. 1, may be required to protect the integrity of the adhesive means (65) such that the indicated adhesive protection means (2) would match the area of the bottom side (60) which has received adhesive means (65). Such adhesive protection means (2) may be a paper strip with a waxy surface (66)such that the adhesive protection means (20 is adequately secured so as to not be removed absent an intentional effort.

The process or method of use of this invention is illustrated in FIGS. 3 through 7. It will be appreciated that the following steps may be employed in attaching a tag attaching apparatus (1) to a container (90); first affixing a tag attaching apparatus (1) to a card (80) or container (90) surface such that the tag attaching apparatus (1) bottom side (60), having or receiving adhesive means (65) adheres to the card (80) or container (90). In this initial step the tag attaching apparatus (1) may be applied such that the bottom side (60) adheres to the card (80) or container (90) surface from proximal the aperture (70) intermediate the aperture (70) and the first end (10) to the first end (10). Thus in the preferred embodiment of the process, the tag attaching apparatus (1) will have initially approximately one-half of the bottom side (60) adhering to the card (80) or container (90) with the remaining approximately one-half of the bottom side (60) free and not attached or adhering.

A second step will be place an interconnecting means (120) such that the interconnecting means (120), when received by the tag attaching apparatus (1) aperture (70) will form an interconnection between the card (80) or container (90) and a care (80) or tag. This step involves looping an elongated interconnection means (120) having a first interconnection end (130), a second interconnection end (140) and a middle (150) intermediate said first interconnection end (130) and second interconnection end (140), for affixing to a second container (90) having attaching aperture means (110). As illustrated in FIGS. 3, 5, 6 and 7, attaching aperture means (110) is depicted as the space between a ribbon (100) on a gift container (90). Such attaching aperture means (110) receiving the first interconnection end (130) with the middle (150) residing within said attaching aperture means (110) and with the first interconnection end (130) and the second interconnection end (140) extending from the attaching aperture means (110) such that the said first interconnection end (130) and the second interconnection end (140) are proximal the other.

Another step in the preferred embodiment of the process is the step of inserting the said first interconnection end (130) and the second interconnection end (140) through the tag attaching apparatus aperture (70). At this point, with the attachment of a greeting card (80), the tag attaching apparatus (1) is folded such that the tag attaching apparatus bottom surface (60) adheres to the container (80) surface from proximal the aperture (70) intermediate the aperture (70) and the second end (20) to the second end (20) where the said first interconnection end (130) and the second interconnection end (140) are protruding from between the bottom side (60) and the card (80) or container (90) surface. In some instances an additional step will be the step of insuring that a portion or remnant of the interconnection means (120) will be exposed. In this latter event, for a gift, the interconnection means (120) likely comprising a decorative ribbon, will have a decorative end or remnant displayed. In the circumstance where the tag attaching apparatus (1) may be used with a shipping container or for a security seal, the exposure of one or both of the first interconnection end (130) or second interconnection end (140) may provide a metal ribbon for use in embossing with a security code or the identity of a quality assurance inspector.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

I claim:

1. A tag attaching apparatus comprising:
a. a elongated planar strip having a top side and a bottom side; a first end and a second end and a first side and a second side;
b. an aperture formed from the top side to the bottom side intermediate the first end and second end; the aperture formed intermediate the first side and the second side;
c. an adhesive means applied to the bottom side; a first adhesive section from the first end to the aperture; a second adhesive section from the second end to the aperture.

2. The device of claim 1 further comprising:
a. the aperture sized to receive an interconnecting means;
b. an adhesive protection means covering the bottom side.

3. A method of attaching a tag to a container comprising the steps of:
a. affixing a tag attaching apparatus, of claim 1, to a container surface such that the tag attaching apparatus bottom surface adheres to the container surface from proximal the aperture intermediate the aperture and the first end to the first end;
b. looping an elongated interconnection means, having a first interconnection end, a second interconnection end and a middle intermediate said first interconnection end and second interconnection end, for affixing to a second container having attaching aperture means; said attaching aperture means receiving the first interconnection end with the middle residing within said attaching aperture means and with the first interconnection end and the second interconnection end extending from the attaching aperture means such that the said first interconnection end and the second interconnection end are proximal the other;
c. inserting the said first interconnection end and the second interconnection end through the tag attaching apparatus aperture;
d. folding the tag attaching apparatus such that the tag attaching apparatus bottom surface adheres to the container surface from proximal the aperture intermediate the aperture and the second end to the second end where the said first interconnection end and the second interconnection end are protruding from between the bottom surface and the container surface.

4. A method of attaching a tag to a container of claim 3 comprising the additional steps of:
a. introducing the interconnection means through the attaching apparatus aperture such that a remnant of the interconnection means will be exposed.
